(19) United States
(12) Patent Application Publication
(10) Pub. No.: US 2002/0033768 A1
(43) Pub. Date: Mar. 21, 2002

(54) System for shifting phase in antenna arrays

(76) Inventors: Teddy Tidal Neeman, Tel Aviv (IL); Yitzhak Birk, Hod Hasharon (IL); Shoshan Hendler, Holon (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/955,992

(22) Filed: Sep. 20, 2001

(30) Foreign Application Priority Data
Sep. 20, 2000 (IL) 138597

(51) Int. Cl. H01Q 3/22

(52) U.S. Cl. 342/372

(57) ABSTRACT

A phased array antenna includes at least one digital modulator for phase shifting the signal of at least one antenna in the array. Each modulator includes a digital modulating element where the element can be a quadrature modulating element.

A delay element using a digital modulating element is discussed. A method for phase shifting the antennas in an array using digital modulators as phase shifters is described, as is a method for phase aligning multiple signals received over multiple paths, again using digital modulators. The phase shift is applied to local oscillator signals that are subsequently mixed with information-carrying signals.

### FIELD OF THE INVENTION

The present invention relates generally to a system and method for shifting phase, in particular shifting phase in antenna arrays.

### BACKGROUND OF THE INVENTION

An array antenna whose beam direction or radiation pattern is controlled primarily by the relative phases of the excitation currents in the elements of the array is called a phased array. Phased arrays are used in radar where fast tracking is required, in direction finding, and in communications where the radiation pattern must be adjusted to different traffic conditions.

Reference is made to FIGS. 1A and 1B which illustrate two prior art receiving antenna array configurations 105 and 107 and FIG. 1C which illustrates a prior art transmitting antenna array 109. For simplicity, each array has two antennas. The receiving arrays 105 and 107 each contain two antennas 2A and 2B, two amplifiers 12A and 12B, two mixers 24A and 24B, a local oscillator 20, a phase shifter 6A, two variable amplifiers 10A and 10B, a summation circuit 5, and a demodulator 60.

In FIG. 1A, a radio frequency signal (RF) is received at antenna 2A. The signal is then fed to amplifier 12A where it is amplified and passed on to mixer 24A. At mixer 24A, the signal is mixed with a constant frequency signal generated by local oscillator 20 to produce an intermediate frequency signal, IF. This mixing process is often called down-conversion and is intended to create an intermediate frequency signal (IF) suitable for demodulation. The IF signal is phase shifted by phase shifter 6A and further amplified by variable amplifier 10A.

The signal arriving at antenna 2B is processed in a manner similar to the signal received at antenna 2A but without being phase shifted. Once the signals from both the phase shifted upper path and the unshifted lower path are summed by summation circuit 5, the unified signal is passed on to demodulator 60 which generates a baseband signal.

The array 107 in FIG. 1B operates in the same way as the array 105 in FIG. 1A. It differs only in the positions of phase shifter 6A and variable amplifiers 10A and 10B. Their placement before mixers 24A and 24B and after amplifiers 12A and 12B in FIG. 1B is the more conventional configuration.

FIG. 1C shows a transmitting array 109 configuration which contains components similar to those found in receiving arrays 105 and 107 of FIGS. 1A and 1B. However, instead of summation circuit 5 as in FIGS. 1A and 1B, there is a signal divider 64 which splits the modulated baseband signal before it travels to transmitting antennas 2A and 2B of array 109. Similarly, in place of demodulator 60 found in FIGS. 1A and 1B, FIG. 1C includes a modulator 62. Phase shifter 6A is located after mixer 24A and before amplifier 12A. The mixing of the signal produced by local oscillator 20 and mixer 24A is often called up-conversion. It effectively takes an intermediate frequency signal (IF) and converts it to a signal suitable for transmission.

It should be noted that arrays 105, 107 and 109 in FIGS. 1A, 1B, and 1C respectively, usually contain additional conventional electronic components, such as band-pass filters. These latter elements filter the RF and IF frequencies Filters and other additional components have not been shown in FIGS. 1A, 1B, and 1C to better focus on and illustrate the principles and components needed for phase shifting.

The signal s(t) emanating from each of the elements in a phased array can be written in the form of a wave, A(t)*cos(ωt+ψ+θ(t)), where A(t) is the amplitude of the wave which is usually a function of time t, ω is the angular frequency of the wave, ψ is the time independent phase of the wave, and θ(t) is a time dependent phase difference. The first term cot represents the instantaneous phase change due to the carrier frequency, while the second term ψ represents the fixed phase offset relative to some reference, and the third term θ(t) represents the phase or frequency modulation. One of the array elements can act as the reference for ψ.

To insure high gains, i.e. high directivity, in the array, the signals (sinusoidal waves) from the elements of the array must interfere constructively (add to each other) in the desired directions in space and interfere destructively (cancel each other) in the remaining directions.

Achieving controllable parameters in antenna arrays, e.g., the gain (directivity) of the array or its polarization, requires that the relative phases ψ and/or amplitudes A of the signal going to each antenna in the case of transmission, or coming from each antenna in the case of reception, be variable. By controlling amplitude and phase, constructive and destructive interference can be satisfactorily manipulated. Parameters in antenna arrays which can be controlled by adjusting the relative phase of the signals include, but are not limited to, beam shaping, beam steering, gain (directivity) and polarization.

The amplitude A(t) of each signal is typically regulated by the use of variable attenuators or variable gain amplifiers. The phase ψ of each signal is normally controlled by elements referred to as phase shifters. Directivity and polarization of the radiation of an antenna array can be controlled by a judicious choice of such amplifiers and phase shifters. U.S. Pat. No. 5,659,322 and PCT Application 99/08400A2 contain examples of antenna arrays that use phase shifters to control polarization of the transmitted or received signals.

There are many types of mechanically adjustable phase shifters with the rotary phase shifter being among the best. Electronically controlled phase shifters using PIN diodes or ferrite materials are used in many phased array antennas. These often contain current-controllable ferromagnetic materials directed by switching electronics. The magnetic fields of these ferromagnetic materials influence and adjust the phase of the signals emitted by or received at the elements of the antenna array.

The above phase shifters are usually of non-negligible size. In a large phased array antenna with many radiating elements, nearly every element requires at least one phase shifter. The phase shifters accordingly take up a measurable volume in the array. These phase shifters, especially those that must be controllable at a high speed, are also expensive, limiting their use in cost-sensitive consumer electronics.

Wireless communication typically entails the use of an “information bearing” signal, such as the output of a microphone, to modulate a carrier signal. The latter is at a much higher frequency and is used to transmit the modulated signal. Modulation in analog systems usually makes use of well-known techniques such as amplitude modulation (AM) or frequency modulation (FM), but modulation can also be effected digitally.

Reference is now made to FIG. 2, which details one type of digital modulator 111. FIG. 2 shows an oscillator 21, not necessarily a local oscillator, a phase splitter 23, two mixers 25A and 25B and a summation circuit 7. Oscillator 21 produces a signal, Acosωt, which is provided to phase splitter 23 and split into in-line (I) and quadrature (Q) components, Acosωt and−Asinωt, respectively. The phases of these components are 90° apart from one another. The two components are then sent to mixers 25A and 25B where they are multiplied by factors k_{c} and kₛ representing the data to be modulated. Thus, k_{c} and kₛ are functions varying between two binary levels.

The mixing procedure produces intermediate frequency signals (IF) of the form k_{c}Acosωt and −kₛAsinωt. These IF signals are then added together by summation circuit 7. By letting k_{c} and kₛ assume the values +1 or −1, the result is a constant amplitude signal with four possible phases. By using two-bit symbols to specify the four possible combinations of (k_{c}, kₛ), one obtains the well-known quadrature modulation scheme. By a proper choice of a small number of additional value pairs for (k_{c}, kₛ), one can produce a quadrature amplitude modulation (QAM) digitally modified oscillator signal. By feeding a sequence of such values for k_{c} and kₛ to the IF signals, one obtains time-varying digitally (QAM) modulated signals.

### SUMMARY OF THE PRESENT INVENTION

Although there are many techniques for controlling the amplitude and/or phase of a signal going to or coming from an antenna, doing so in a very compact, inexpensive way that can be integrated easily with other electronic processing remains an important existing problem. The current invention teaches the use of a small-size phase control component, fabricated using low cost silicon technology, which can be integrated with other processing steps and controlled by conventional electronics.

The current invention uses a digital modulator, for example a QAM, to produce phase shifts. The system and methods described herein are based on digital modulation and can generate phase shifts of any desired angle.

It is an object of the present invention to provide a general method for phase shifting and in particular shifting phase in antenna arrays. It is another object of the present invention to produce delay lines using digital modulators.

Within the context of what is written herein below, the term replication is generally associated with a signal divider, where the division is not to be interpreted as strict division, but as copying, replicating or cloning. Except as where denoted otherwise, the output of the signal dividers used in this invention replicate or copy an input signal without changing any of the input signal's properties, (amplitude phase etc.) The term replication as used herein below can also include carrying or transmitting an identical signal to different locations, e.g., through multiple conductors of a printed circuit board.

The present invention teaches a phased antenna array comprising a plurality of antennas and at least one digital modulator. Each of the at least one digital modulators shifts the phase of the signal of a different antenna in the array. The phase shifting is effected in a manner generally unrelated to the information, if any, being received or transmitted.

The invention also teaches a phase shifter for an antenna in a phased antenna array comprising a digital modulating element and a controller for controlling the digital modulating element. The digital modulating element produces a phase shift in the antenna signal.

The phase shifter of the invention includes a digital modulating element further comprising a phase splitter, where the phase splitter receives the antenna signal as input. The phase splitter can be either a quadrature phase splitter or a non-quadrature phase splitter. The phase splitter is controlled by a controller which also includes a means for generating pairs of phase shift values, both together defining a phase shift. The digital modulating element can comprise a phase splitter and at least one multiplier, each multiplier receiving an output of the phase splitter and one of the phase shift values. The digital modulating element can be a quadrature modulating (QM) element.

In one embodiment, the invention teaches a phase shifter for an antenna of a phased antenna array where the phase shifter comprises a digital modulating element. The element receives at least one signal from a local oscillator. The phase shifter further comprises a controller for controlling the digital modulating element, thereby producing a desired phase shift of the oscillator signal.

In yet another embodiment, the invention recites a phase shifter comprising a means for modifying two phase split signals thereby affecting the phase of the sum of the modified split signals. The phase shifter also comprises a controller for controlling the means for modifying two phase split signals so as to produce a desired phase shift in the antenna signal.

In yet a further embodiment, a phase shifter for signals is recited where the signals have at least one frequency component and the phase shifter comprises a digital modulating element. The signals can be sinusoidal or non-sinusoidal.

The invention teaches a method for phase shifting signals received from antennas in a receiving antenna array. The method comprises the steps of shifting the phase of at least one of the received signals with a digital modulating element, and then summing the at least one phase shifted signal and any non-phase shifted signals received from the antennas. The phase shifting is effected in a manner generally unrelated to the information, if any, being received.

In another embodiment the invention teaches a method for phase shifting signals produced by at least one local oscillator in an antenna array. The method comprises the step of shifting the phase of at least one of the signals with a digital modulating element. The antenna array can be a receiving or a transmitting array. The phase shifting is effected in a manner generally unrelated to the information, If any, being received or transmitted.

In a further embodiment, the invention recites a method for phase shifting signals transmitted by antennas in a transmitting antenna array. The method comprises the steps of modulating a signal to be transmitted and replicating the modulated signal into at least two identical copies of the modulated signal. The replication step is followed by shifting the phase of at least one of the two identical copies with a digital modulating element. Unlike in the case of phase or frequency modulation, the phase shift is effected in a manner generally unrelated to the information, if any, being transmitted.

The invention discusses delay elements. It recites a delay element for narrow band antenna signals where the delay element comprises at least one digital modulating element, where the at least one digital modulating element receives the signals. The delay element further comprises a controller for controlling the digitally modulating element thereby producing a delay in the antenna signals. The at least one delay element can be a cascade of digital modulating elements.

In one embodiment, the invention recites a method for phase shifting signals received by n array elements in a receiving antenna array. The method comprises the steps of generating at least one local oscillator signal, replicating the signal to make n identical copies, a different copy for each array element, and phase shifting at least one copy of the replicated signal. Phase shifting is effected by a digital modulating element. Each copy of the local oscillator signal is mixed with the signal received by its corresponding array element. Finally, the mixed signals are summed. The phase shift is effected in a manner generally unrelated to the information, if any, being received.

In yet another embodiment, the invention recites a method for phase shifting signals received by array elements in a receiving antenna array. The method comprises the steps of generating a local oscillator signal and replicating the local oscillator signal to form n copies of the signal, a different copy for each array element, thereby creating a group of first intermediate signals (IF1). A second local oscillator signal is generated and replicated to form a different copy for each element. These copies are mixed with a member of the first group of intermediate signals (IF1) thereby forming a second group of intermediate signals (IF2). The phase of at least one copy of at least one of the local oscillator signals is shifted after at least one of the replicating steps, the phase shifting effected by a digital modulating element. Finally, the second group of intermediate signals (IF2) is summed.

In one embodiment, the invention recites a method for phase shifting a signal transmitted by an array of n elements in a transmitting antenna array. The method comprises the steps of modulating a signal and replicating the modulated signal into n identical intermediate signals (IS), a different copy for each of the array elements. This replicating step is followed by generating a local oscillator signal which is then replicated into n copies, again a different copy for each array element. At least one copy of the local oscillator signal is then phase shifted with the phase shifting effected by a digital modulating element. Finally, the copies of the local oscillator signal are mixed with at least one of the n intermediate signals.

In yet another embodiment, a method for phase shifting a signal transmitted by an antenna array of n elements is taught. The method comprises the steps of modulating a signal and replicating the modulated signal into at least n intermediate signals (IS1), a different one for each of the n array elements. The next step entails generating a local oscillator signal and replicating that signal into n identical copies. The generating step is followed by mixing a copy of the first local oscillator signal with an intermediate signal (IS1), thereby forming a second group of intermediate signals (IS2). Generating a second local oscillator signal and replicating it into identical copies follows the mixing step. These copies are mixed with the second group of intermediate signals (IS2), thereby forming a third group of intermediate signals (IS3). Finally, at least one copy of one local oscillator signal is phased shifted after one of the generating steps, the phase shifting being effected by a digital modulating element.

The invention also recites a method for phase aligning the phases of multiple signals carried or travelling over different paths. This method comprises the step of shifting the phase of at least one of the multiple signals so that the different paths have equivalent effective lengths or effective lengths that differ by a prescribed amount. The phase shifting is effected by at least one digital modulating element in a manner generally unrelated to the information, if any, being received or transmitted. The multiple signals can be carried over the multiple conductors of a bus on a printed circuit board. Similarly, the multiple signals can be carried over different wires in a cable. Additionally, the multiple signals can be carried over channels at different carrier frequencies.

In one embodiment, the invention recites a method for modifying the time that multiple signals travelling over different paths arrive at a given point along the paths. The method comprises the step of delaying the multiple signals travelling over different paths thereby generating paths of equivalent effective lengths. The delay is effected by at least one digital modulating element in a manner generally unrelated to the information, if any, being received or transmitted.

The invention also teaches an antenna system comprising at least one antenna and at least one digital modulator. The at least one digital modulator shifts the phase of a first signal by control of a second signal, the phase shift being generally independent of the information being carried by the first signal. The antenna system can be a receiving or transmitting antenna system.

In a further embodiment of the invention, a transmission phased antenna array is taught which includes a plurality of N antennas and a plurality of N digital modulators. Each of the digital modulators modulates the signal of a different antenna from among the plurality of antennas. At least one, but not more than N−1 digital modulator shifts the phase of the signal of a different antenna from among the plurality of antennas. The phase shifts are generally of different magnitudes for each antenna.

In another embodiment of the invention a method is taught for phase shifting and modulating signals produced by at least one local oscillator in a transmitting antenna array. The method comprises the step of shifting the phase of at least one of the signals with a digital modulating element. The modulating element also modulates the signals.

### BRIEF DESCRIPTION OF THE DRAWINGS

The present invention will be understood and appreciated more fully from the following detailed description taken in conjunction with the drawings in which:

FIGS. 1A and 1B are schematic illustrations of prior art receiving array configurations;

FIG. 1C is a schematic illustration of a prior art transmitting array configuration;

FIG. 2 is a schematic illustration of a prior art method for producing quadrature amplitude modulation (QAM);

FIG. 3 is a schematic illustration for digitally modulating an incoming signal thereby generating a phase shift according to the present invention;

FIG. 4A is a phasor diagram illustration of the relationship between the modulating signals and the angle of the phase shift according to the current invention when the signals to be modulated are 90° apart;

FIG. 4B is a phasor diagram illustration of the general relationship between modulating signals and the angle of the phase shift according to the current invention when the signals to be modulated are at any angle a apart, where a is not necessarily 90°;

FIG. 5 is a schematic illustration of a receiving array configuration where quadrature modulation is used to produce a phase shift;

FIG. 6 is a schematic illustration of a typical quadrature modulator that can be used in FIG. 5 to phase shift a signal;

FIGS. 7A, 7B and 7C are three schematic illustrations of additional receiving array configurations where quadrature modulation is used to phase shift the signal;

FIG. 8 is a schematic diagram illustration of a transmitting array configuration where quadrature modulation is used to produce a phase shift;

FIG. 9 is a schematic diagram illustration of an embodiment of the present invention;

FIG. 10 is a schematic illustration of yet another alternative embodiment of the present invention;

FIG. 11A is a schematic illustration of a further embodiment of a receiving array;

FIG. 11B is a schematic illustration of another embodiment of a transmitting array; and

FIG. 12 is a schematic illustration of a transmission array using the present invention to both phase shift and modulate the transmitted signals.

Similar elements in the Figures are numbered the same.

### DETAILED DESCRIPTION OF PREFERRED EMBODIMENTS

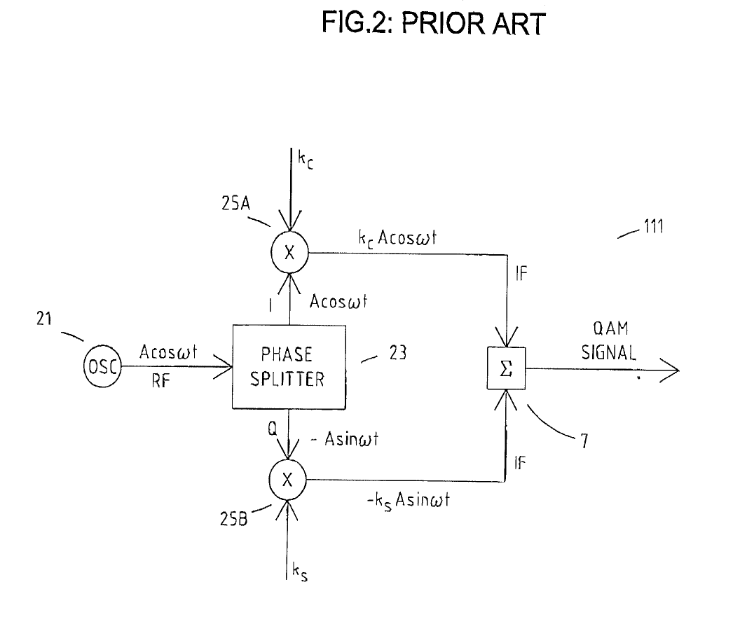

Applicant has realized that QAM modulation as described in FIG. 2 above can be extended and used as a general method to provide a phase shift which is independent of any information being transmitted or received.

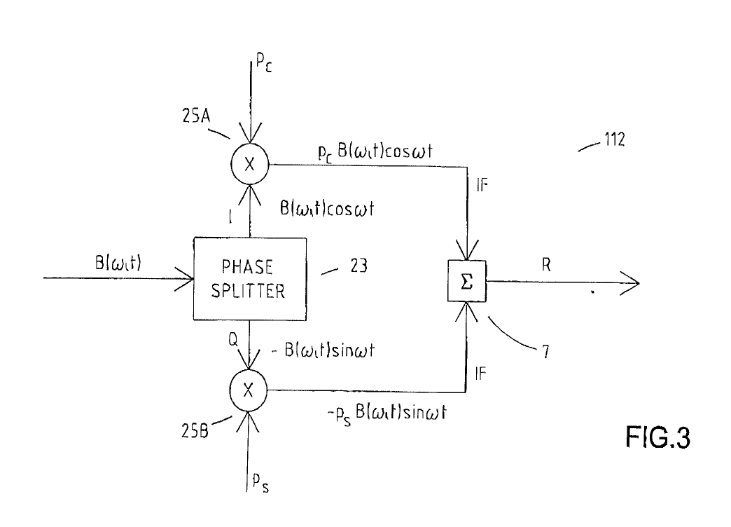

Reference is now made to FIG. 3 which illustrates the application of QAM to alter the phase of an externally generated signal B(ωᵢ,t). B(ωᵢ,t) is a function of time t, and has i components each having a different angular frequency ωᵢ;. FIG. 3 is essentially the same as FIG. 2 but with an externally generated signal, B(ωᵢ,t), such as an antenna signal replacing the oscillator generated signal Acosωt of FIG. 2. In FIG. 2. where QAM is used, the transmitted information is used for determining the phase shift at any given time, thus modulating the carrier. In FIG. 3, the phase shift is determined by considerations that are generally independent of the information being transmitted and, in certain embodiments, the phase shift is in fact applied to the information bearing signal. If such information is present, it is not used to modulate the signal. While FIG. 3 shows an externally generated signal B(ωᵢ,t), it should be readily evident that the phase shifter of the present invention can also be used with a pure cosine (oscillator) signal as well.

As in FIG. 2 FIG. 3 shows a phase splitter 23, two mixers 25A and 25B and a summation circuit 7. The externally generated signal B(ωᵢ,t) is provided to phase splitter 23 which splits the signal into in-line (I) and quadrature (Q) components, B(ωᵢ,t)cosωt and −B(ωᵢ,t)sinωt, respectively. The two components are then fed into mixers 25A and 25B where they are mixed with, or more exactly mathematically multiplied by, factors P_{c} and pₛ. In the present invention, p_{c} and pₛ are either constant or very slowly varying with time. The resultant IF signals have the forms p_{c}B(ωᵢ,t)cosωt and −pₛB(ωᵢ,t)sinωt and are added together by summation circuit 7 to produce a modified externally generated signal, R.

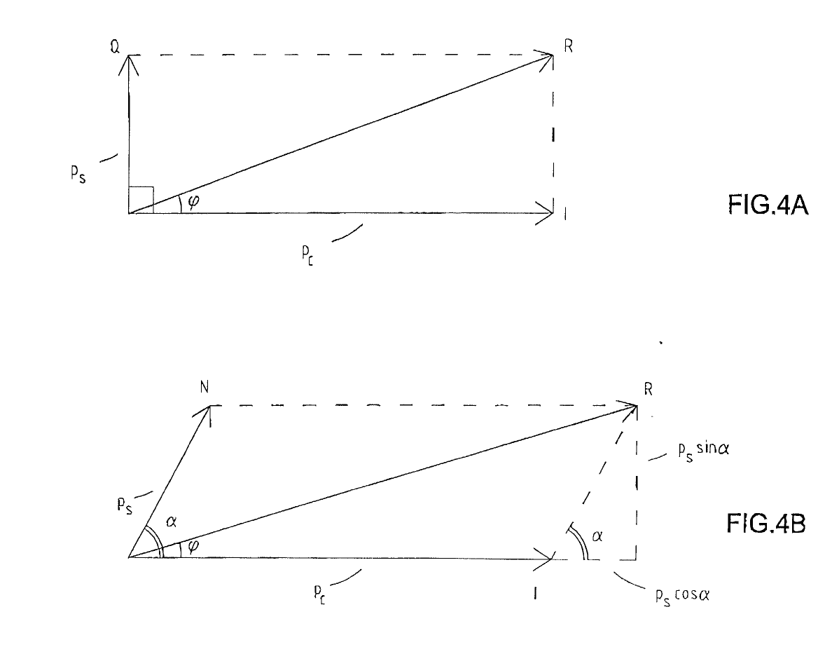

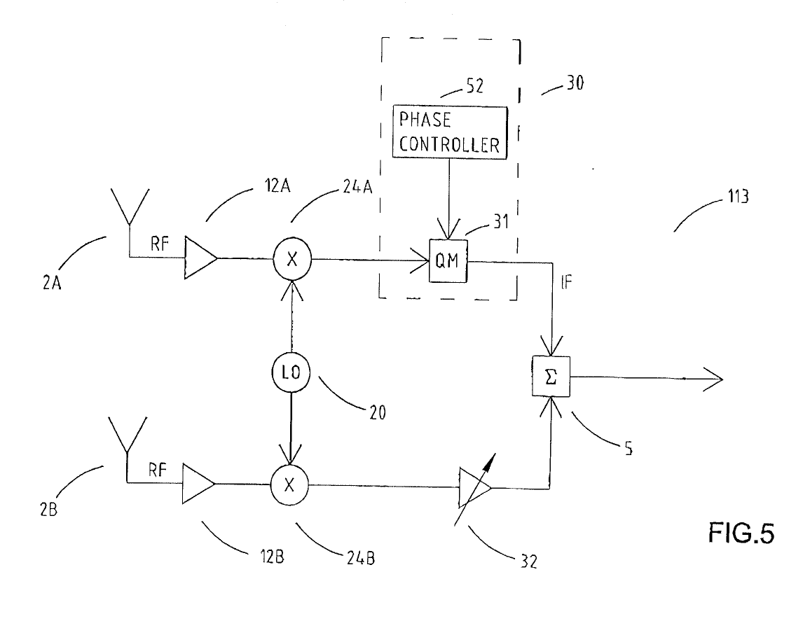

Applicant has realized that the modified externally generated signal R produced in FIG. 3 is effectively a phase shifted copy of the input signal. More importantly, unlike the QAM modulation of FIG. 2, the phase shifts are generally independent of the information being transmitted or received. This can best be seen by reference to FIG. 4A.

FIG. 4A is a phasor diagram of two input signals, I and Q, which vectorially add to produce output signal R. Signals I and Q of FIG. 4A are equivalent to the two components B(ωᵢ,t)cosωt and −B(ωᵢ,t)sinωt of FIG. 3. The amplitudes of both the I and Q components in FIG. 4A are identical prior to their multiplication by factors pₛ and p_{c}. Once the I and Q components are multiplied, they may have different amplitudes as shown in FIG. 4A. As realized by Applicant, the sum R, the output of summation circuit 7, is phase shifted by ψ radians.

The size of the phase shift ψ is defined by FIG. 4A. Using elementary trigonometry, phase shift ψ is defined by tan ψ=pₛ/p_{c}. There is no change in the amplitude of resultant vector R when pₛ and p_{c} have values such that pₛ²+p_{c}²=1. To change the amplitude of resultant R by a factor of K, factors pₛ and p_{c} must be such that in addition to tan ψ=pₛ/p_{c}, pₛ²+p_{c}²=K².

Turning now to FIG. 4B, where a more generalized phasor diagram is illustrated. It is readily observed that even when a non-quadrature phase splitter s used, any desired phase shift ψ can be generated. The shift is dependent on angle α, the angle between the two split components, and on a proper choice of factors pₛ and p_{c}. Non-quadrature phase splitters, which split signals into two components separated by an angle α, are readily available commercially. Alternatively, any improperly manufactured 90° phase shifter, that is one that splits signals so that a 90°, can be used, provided that angle α is known.

When α is not 90°, the relationship between pₛ and p_{c} required to produce a phase shift of ψ radians is as shown in FIG. 4B. Specifically, if after the phase splitter has split the signal into two phasors, I and N, where the second phasor N points at an angle α relative to the first phasor I, a desired phase shift of ψ radians can be obtained by selecting p_{c} and pₛ, such that:

(pₛ sin α)/(p_{c}+pₛ·cos α)=tan ψ, Eq. 1

and

(p_{c}+pₛ·cos α)²+(pₛ·sin α)²=C² Eq. 2

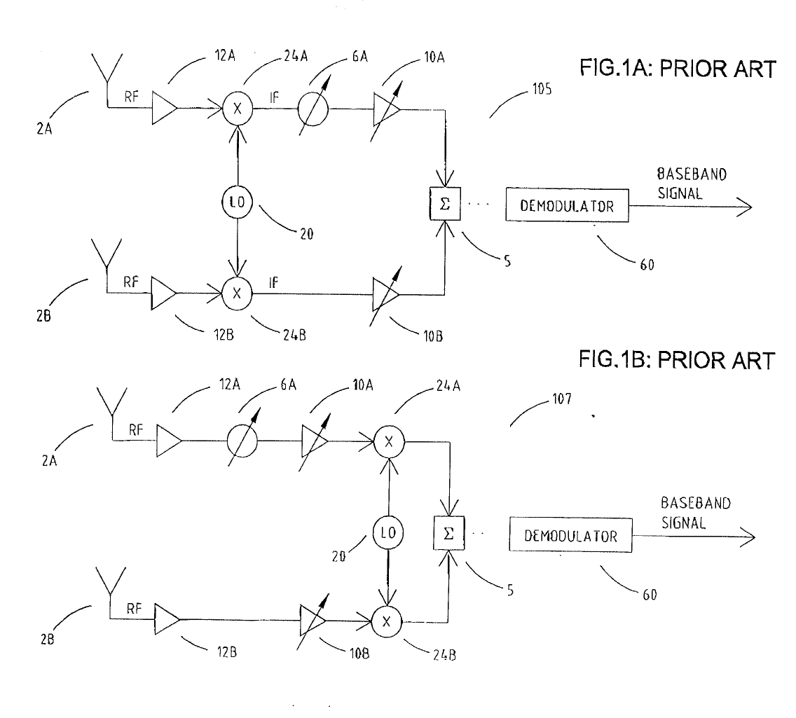

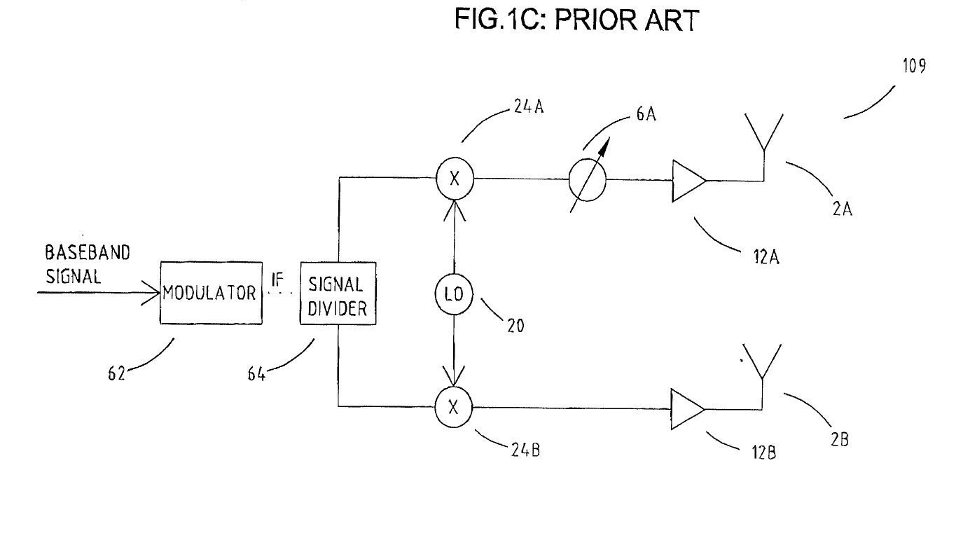

Reference is now made to FIG. 5 where the integration of digital quadrature modulation with phased array antennas as taught by the present invention is more directly illustrated. FIG. 5 shows a receiving array 113 which is very similar to the one shown in FIG. 1A, except that phase shifter 6A and variable amplifier 10A of FIG. 1A have been replaced by a quadrature modulator phase shifter (QMPS) 30, In accordance with the present invention, QMPS 30 produces the phase shift previously generated by phase shifter 6A.

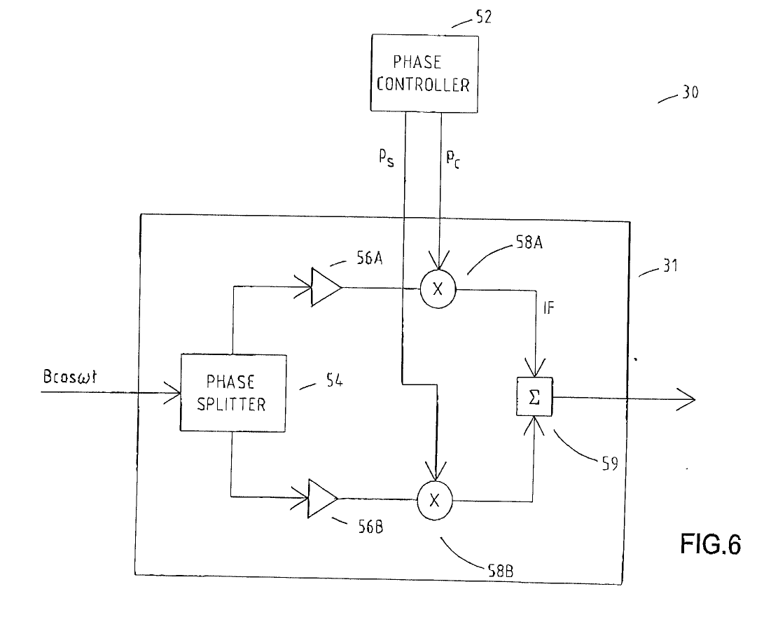

FIG. 6 is a detailed schematic view of QMPS 30 used to effect a phase shift. It includes a quadrature modulator (QM) chip 31 and a phase controller 52. QM chip 31 operates generally as described above and includes a phase splitter 54, two amplifiers 56A and 56B, two mixers 58A and 58S, and a summation circuit 59. Controller 52 generates modulating inputs pₛ and p_{c} from a received desired phase, as per the equations above, and sends them to QM chip 31 which uses them to shift the phase of the input signal Bcosωt by an amount ψ.

An exemplary off-the-shelf quadrature modulator (QM) chip 31 which can be used to phase shift a signal is a QM chip manufactured by Analog Devices of Norwood, Mass. (part AD 8346). The size of the part is smaller than phase shifters of the prior art and is on the order of 6×5×1 mm. Other similar chips are also commercially available.

It should be noted that while QMPS 30 in FIG. 6 shows amplifiers 56A and 56B on chip 31, these are unnecessary. A QM chip 31 without amplifiers 56A and 56B could also be used, and separate variable amplifiers could be positioned between chip 31 and the next element up, or more preferably, down the line.

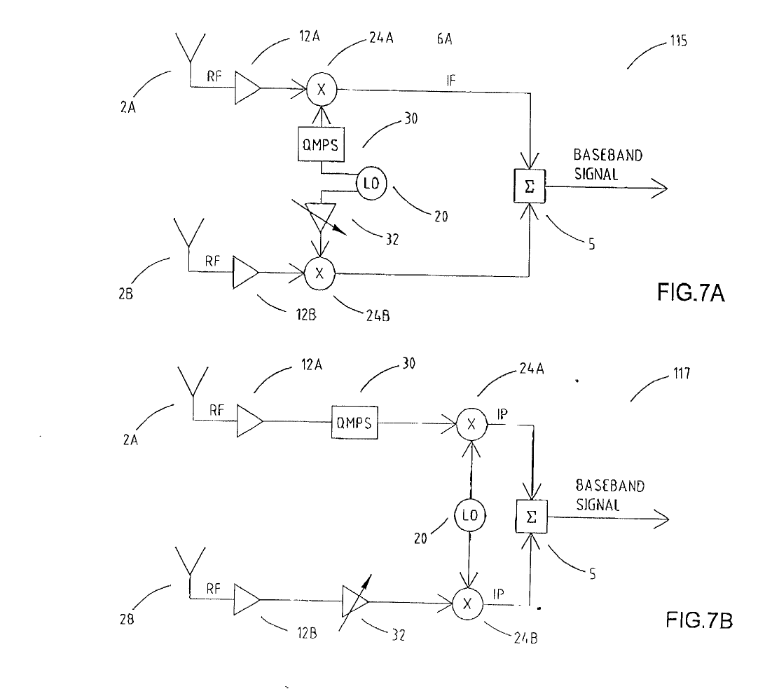

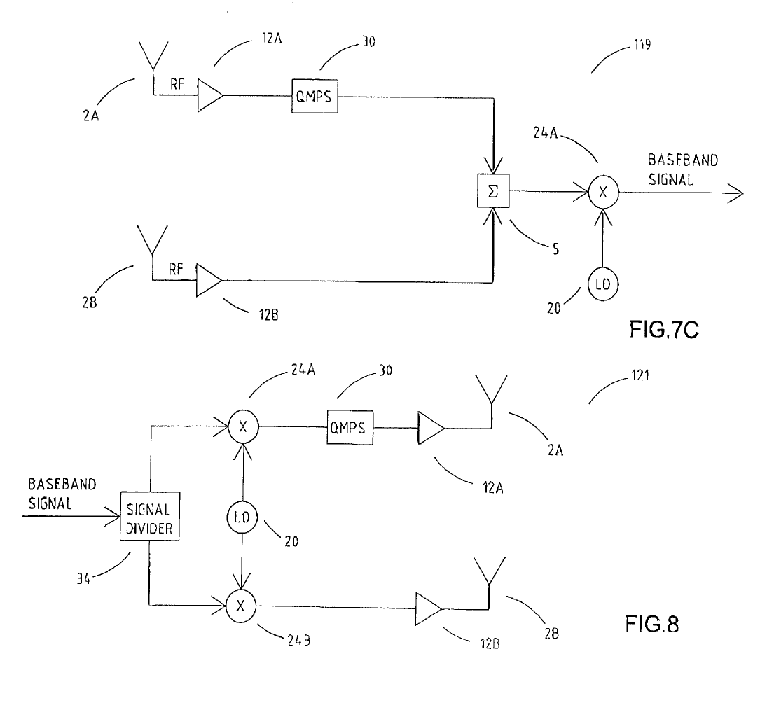

Referring to FIGS. 7A, 7B and 7C, three additional receiving array configurations, 115, 117, and 119 are shown, all of which use QMPS elements 30 as phase shifters. The components and operation of these arrays are similar to the components and operation of array 113 described in FIG. 5. The intent of these Figures is to show that the placement of QMPS 30 is flexible. FIG. 7A shows QMPS 30 situated between local oscillator 20 and mixer 24A; FIG. 7B shows QMPS 30 located between incoming amplifier 12A and mixer 24A. Finally, FIG. 7C shows QMPS 30 placed between amplifier 12A and summation circuit 5. The phase shifts, unlike QAM modulation, are generally independent of the information being transmitted or received regardless of the location at which the phase shift is effected.

While the placement of QMPS 30 is not overly restrictive, certain precedence conditions should be obeyed. For reception, the phase shift should precede the summing operation and the summing operation should precede demodulation. For transmission, modulation precedes the divider operation, which precedes phase shifting.

FIG. 8 is a transmitting array 121 similar to the one shown in FIG. 1C. All the elements in FIGS. 1C and 8 are identical with the exception of phase shifter 6A and amplifier 12A. In FIG. 8, these last two components have been replaced by QMPS 30 as shown in FIG. 6. Transmitting array 121 works in a manner analogous to receiving arrays 113, 115, 117 and 119 shown in FIGS. 5, 7A, 7B and 7C but with the signal travelling in the opposite direction.

The above description of the phase and amplitude changes was made with reference to a signal with a single frequency, ω. However, it will be readily appreciated by one skilled in the art, that any signal can be manipulated using the method of this invention. Specifically, any signal can be represented as a sum, sometimes even an infinite sum, of single-frequency signals. These signals can each have their own frequency, amplitude and phase. From the above, it can readily be seen that the amplitude changes and phase shifts produced by QM phase shifters are independent of frequency. Consequently, the amplifications (or attenuations) and phase shifts would apply to every component of a signal produced by a Fourier transformation. Since digital modulation operations are all linear, all components of the resulting signal will have the same desired amplification or attenuation and every one of its components will undergo the same phase shift of φ radians.

In certain cases, it is desirable to control the relative path lengths of signals going through different elements of an array. This is equivalent to controlling the relative time delay through these paths. For narrow band signals, i.e., ones in which the spectral interval occupied by the signal is very small relative to a center frequency, control of delay can be shown to be closely approximated by control of phase. Control of delay, therefore, can be effected by the same phase shifters used primarily to shift the phase of a signal.

The method of the present invention can thus also be used as a controllable delay line, capable of delaying a signal by an arbitrary amount of time that is smaller than the period of the signal. In addition, according to the current invention, by cascading several phase shifting elements one can delay a narrowband signal by any arbitrary length of time.

It should be evident to those skilled in the art that the present invention can be applied to any form of signal, not only to sinusoidal signals. Any waveform, for example a V-shaped signal, can be phase shifted by the digital modulation elements of the present invention.

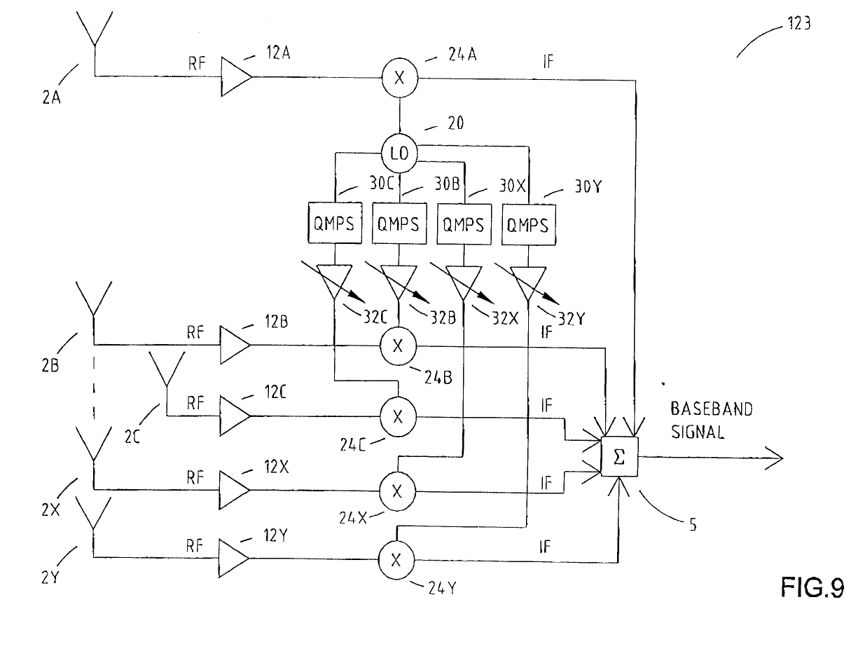

In the embodiment described in FIG. 7A above, the phase shift is applied directly to a local oscillator (LO) signal. In another embodiment, shown in FIG. 9 to which reference is now made, a plurality of array element signals can be phase shifted by first phase shifting the signal generated by a single local oscillator.

Antenna array 123 is analogous to array 115 in FIG. 7A. Array 123 includes antennas 2A, 2B, 2C 2X and 2Y, mixers 24A, 24B, 24C, 24X, and 24Y, amplifiers 12A, 12B, 12C, 12X, and 12Y, quadrature modulator phase shifters (QMPS) 30B, 30C, 30X, and 30Y, variable amplifiers 32B, 32C, 32X and 32Y and summation circuit 5. Each of the QMPSs 30B, 30C, 30X, and 30Y phase shifts an oscillator signal produced by a single local oscillator 20. Mixers 24B, 24C, 24X and 24Y mix the phase shifted LO signals with the RF signals of the respective array elements Mixer 24A mixes the unshifted LO signal with the RF signal from antenna 2A. All the mixed signals are then summed by summation circuit 5 exactly as in FIG. 7A. While not shown, it should be apparent that the amplitude of the signal can also be varied. This would require the addition of appropriate amplifiers or attenuators to the system, either before or after mixers 24B, 24C, 24X and 24Y.

In an analogous embodiment, a transmission array can be constructed which is similar to array 121 of FIG. 8 but where a plurality of antenna signals can be phase shifted by phase shifting copies of the signal generated by a single local oscillator.

The present invention has been discussed as being useful in conventional phased arrays. However, use of the invention in other types of systems is also possible. Phase shifters of the present invention can be used in any system in which signals arrive over multiple paths, each path having a slightly different length and in which “alignment” of the signals is required. This could be the case for the wires of a multi-conductor bus in a computer or switch. Since the path lengths of the wires are all slightly different, a quadrature modulator phase shifter (QMPS) acting as a delay element can be used to equalize the path lengths. The use of digital modulators in such systems can also be thought of as “time-alignment” of signals travelling over paths having different lengths.

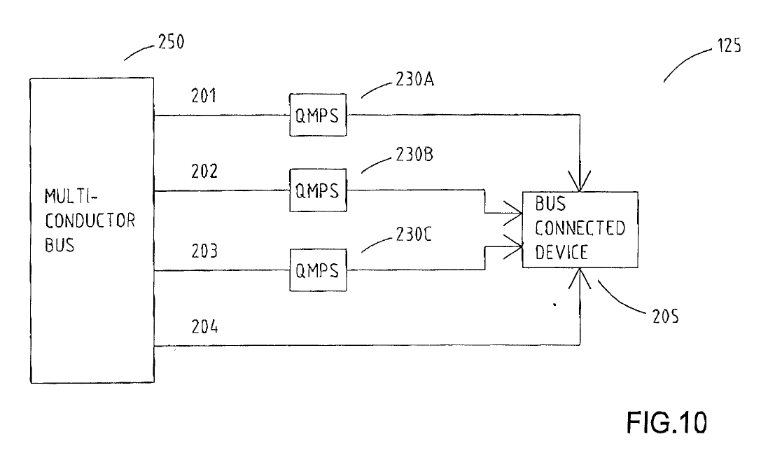

Reference is now made to FIG. 10, where the above embodiment is illustrated. FIG. 10 shows system 125 which includes a plurality N of wires, here four wires, over which a signal is transmitted from a multi-conductor bus 250. In the Figure, four wires 201, 202, 203, and 204 are shown connected to multi-conductor bus 250 with three QMPSs 230A, 230B, and 230C connected to wires 201, 202, and 203. The signals are then inputted to bus connected device 205, such as a computer or switch. While FIG. 10 shows a multi-conductor bus for a computer, switch, or other such device, similar embodiments can be used with systems containing multiple transmission or receiving channels, printed circuit boards, or multi-wire cables.

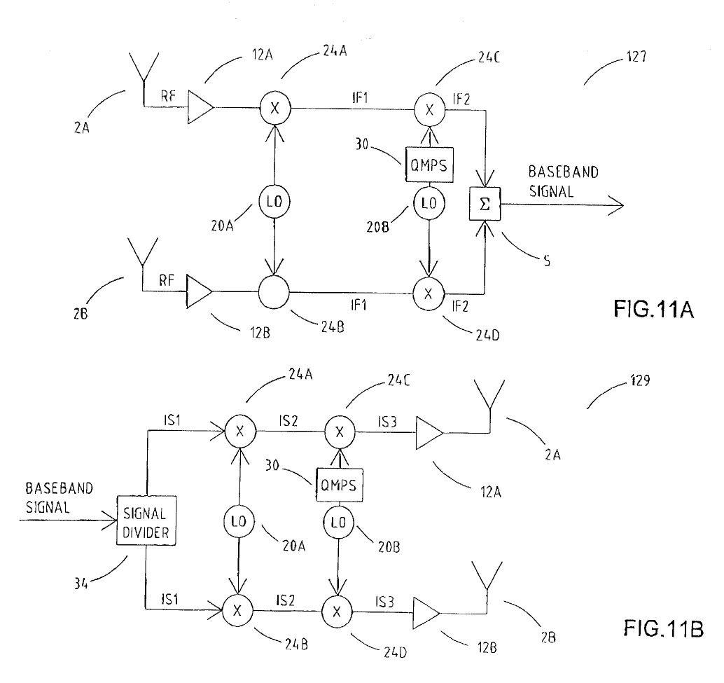

Reference is now made to FIGS. 11A and 11B where additional embodiments are shown. The embodiments describe phase shifted array elements having multiple up- or multiple down-conversions. FIG. 11A shows array 127 which includes antennas 2A and 2B, amplifiers 12A and 12B, mixers 24A, 24B, 24C and 24D, local oscillators 20A and 20B, quadrature modulation phase shifter (QMPS) 30 and summation circuit 5. The operation of the array is identical to the receiving arrays previously described (FIGS. 5, 7A, 7B and 7C) with the addition of a second down-conversion provided by local oscillator 20B. QMPS 30 is located between second oscillator 20B and mixer 24C and phase shifts the phase of the signal generated by second oscillator 20B.

It should be evident that QMPS 30 can be positioned in other locations as suggested by FIGS. 5, 7A, 7B and 7C. It is also obvious that QMPS 30 can be located between first local oscillator 20A and mixer 24A. It is further obvious that the signals of both local oscillators 20A and 20B can be phase shifted concurrently.

FIG. 11B illustrates a transmitting array 129, where the components and their operation are similar to those shown in FIG. 8. The sole feature in FIG. 11B not found in FIG. 8 is a second up-conversion provided by local oscillator 20B. The operation of transmitting array 129 is analogous to the operation of receiving array 127 having two down-conversions discussed with FIG. 11A.

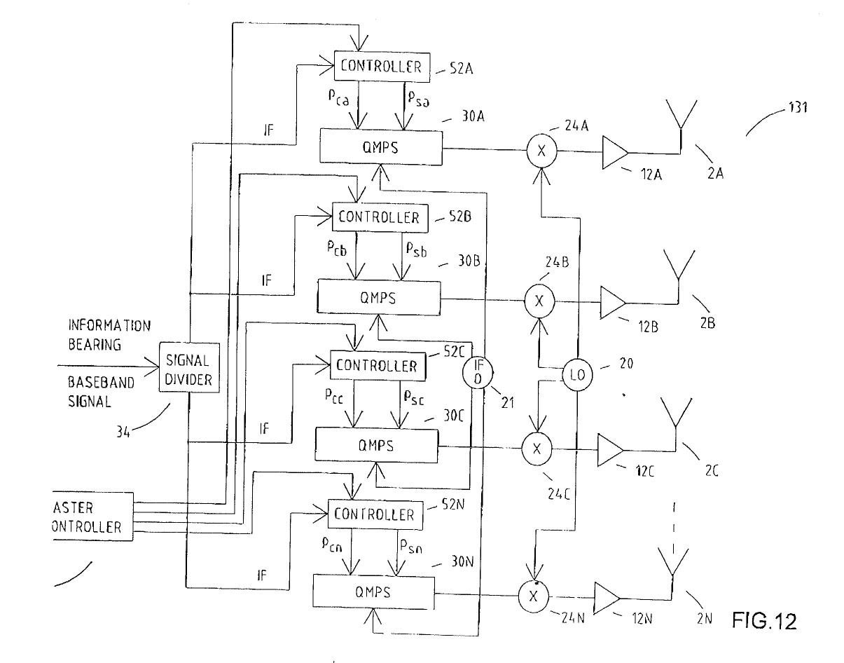

In previous embodiments, the phase shifting aspect of a QMPS has been emphasized. However, a QMPS still retains its ability to modulate a signal. Reference is now made to FIG. 12 where a transmitting array 131 is shown. The embodiment in FIG. 12 represents joint modulation and phase shifting of signals transmitted from different antennas of an array. Array 131 includes a signal divider 34, a local oscillator and an intermediate frequency (IF) oscillator (IFO) 21, It also comprises N antennas 2A through 2N, amplifiers 12A through 12N, mixers 24A through 24N, QMPSs 30A through 3ON and controllers 52A through 52N. Finally array 131 contains a master controller 55.

Signal divider 34 copies an information bearing baseband signal into N identical signals, one signal for each of the corresponding N transmitting antennas of the array. IF oscillator (IFO) 21 generates a signal which is sent to each of the N QMPSs 30A-30N. Each OMPS 30 operates on its associated IF signal, modulating and phase shifting it as described herein. The modulation and phase shifting by each of QMPSs 30A-30N is controlled by its controller 52A-52N. Controllers 52A-52N receive information relating to the digitized information bearing signal Controllers 52A-52N also receive information from master controller 55 which indicates the required relative phase shift for each antenna in the array, the phase shifts being independent of the information transmitted. On that basis controllers 52A-52N determine the pₛ and p_{c} values required to effect the desired phase shift and modulation of their respective IF signals. The modulated and phase shifted IF signals proceed to their respective mixer 24A-24N where they are mixed with a signal supplied by local oscillator 20 and up-converted. The mixed signals then proceed on to their respective antennas 2A-2N passing through amplifiers 12A-12N.

Each controller generates a different set of pₛ and p_{c} factors based on the phase shifting and modulation needed by its IF signal. The p_{c} and pₛ produce an angular shift of the signal which can be decomposed into two parts and represented as Ψ_{M}(t)+ψₙ(t). Ψ_{M}(t) is identical for each of the IF signals going to the N array elements of FIG. 12 and represents the modulation of the IF signal at time t. ψₙ(t) is the relative phase shift required for array element n, where n is such that 0≦n≦N−1. ψₙ(t) can be, and usually is, different for each element.

It should be readily apparent that while in this embodiment we have discussed modulation of the signals in terms of phase modulation, the QMPSs could also concurrently modulate amplitude. Alternatively, amplitude modulation could be effected separately by an appropriate choice and positioning of additional electronic components, such as variable amplifiers.

It should also be readily evident that in this embodiemnt, as in FIGS. 5, 7B, 7C and 8, the QMPSs can be placed before or after the up-conversion at mixers 24A-24N.

In what has been described above, the term or component signal divider should not to be interpreted as effecting strict division. Rather it copies, replicates or clones a signal. Except as where denoted otherwise, the signal dividers used in this invention replicate or copy an input signal without changing any of the input signal's properties, (amplitude, phase etc.) The term replication as used above can also include carrying or transmitting an identical signal to different locations, e.g., through multiple conductors of a printed circuit board.

will be appreciated by persons skilled in the art that the present invention is not limited by what has been particularly shown and described herein above. Rather the scope of the invention is defined by the claims that follow:

1. A phased antenna array comprising:
a plurality of antennas; and
at least one digital modulator, wherein each of said at least one digital modulator shifts the phase of the signal of a different antenna from among said plurality of antennas.

2. A phased antenna array according to claim 1 wherein said at least one digital modulator phase shifts the phase of the signal in a manner generally unrelated to the information, if any, being received or transmitted by said array.

3. A phase shifter for an antenna of a phased antenna array, the phase shifter comprising:
a digital modulating element receiving an antenna signal from said antenna and
a controller for controlling said digital modulating element to produce a desired phase shift in said antenna signal.

4. A phase shifter according to claim 3 wherein said digital modulating element comprises a phase splitter and wherein said phase splitter receives said antenna signal as input.

5. A phase shifter according to claim 4, wherein said phase splitter is selected from a group consisting of a quadrature phase splitter and a non-quadrature phase splitter.

6. A phase shifter according to claim 3 wherein said controller includes means for generating two phase shift values together defining a phase shift and wherein said digital modulating element comprises a phase splitter and at least one multiplier, each of said at least one multiplier receiving an output of said phase splitter and one of said phase shift values.

7. A phase shifter according to claim 3 wherein said digital modulating element is a quadrature modulating (QM) element.

8. A phase shifter for an antenna of a phased antenna array, the phase shifter comprising:
a digital modulating element receiving at least one signal from a local oscillator; and
a controller for controlling said digital modulating element to produce a desired phase shift in said oscillator signal.

9. A phase shifter comprising:
means for modifying two phase split signals to affect the phase of the sum of the modified split signals; and
a controller for controlling said means for modifying two phase split signals so as to produce a desired phase shift in said antenna signal.

10. A phase shifter for signals wherein said signals have at least one frequency component, said phase shifter comprising a digital modulating element.

11. A phase shifter according to claim 10, wherein said signals are sinusoidal.

12. A phase shifter according to claim 10, wherein said signals are non-sinusoidal.

13. A method for phase shifting signals received from antennas in a receiving antenna array, the method comprising the steps of:
shifting the phase of at least one of said received signals with a digital modulating element; and summing the at least one phase shifted signal and any non-phase shifted signals received from said antennas.

14. A method for phase shifting signals according to claim 13 wherein said phase shifting is effected in a manner generally unrelated to the information, if any, being received.

15. A method for phase shifting signals produced by at least one local oscillator in an antenna array, the method comprising the step of:
shifting the phase of at least one of said signals with a digital modulating element.

16. A method for phase shifting signals produced by at least one local oscillator in an antenna array according to claim 15 wherein the antenna array is a receiving array.

17. A method for phase shifting signals produced by at least one local oscillator in an antenna array according to claim 15 wherein the antenna array is a transmitting array

18. A method for phase shifting signals produced by at least one local oscillator in an antenna array according to claim 15 wherein said phase shifting is effected in a manner generally unrelated to the information, if any, being received.

19. A method for phase shifting signals transmitted by antennas in a transmitting antenna array, said method comprising the steps of:
modulating a signal to be transmitted;
replicating said modulated signal into at least two identical copies; and
shifting the phase of at least one of said at least two identical copies with a digital modulating element.

20. A method for phase shifting signals transmitted by antennas in a transmitting array according to claim 19 wherein said phase shifting is effected in a manner generally unrelated to the information, if any, being transmitted.

21. A delay element for narrow band antenna signals, the delay element comprising:
at least one digital modulating element, wherein said at least one element receives said signals; and
a controller for controlling said digitally modulating element to produce a delay in said antenna signals.

22. A delay element according to claim 21 wherein said delay element comprises a cascade of said digital modulating elements.

23. A method for phase shifting signals received by a receiving antenna array of n array elements, said method comprising the steps of:
generating at least one local oscillator signal;
replicating said at least one local oscillator signal into N copies, a different copy for each array element;
shifting the phase of at least one of said copies of said at least one local oscillator signal, said phase shifting effected by a digital modulating element;
mixing said copies of said at least one of said local oscillator signal with said signals received by said array elements; and
summing said mixed signals received from said elements of said array.

24. A method for phase shifting signals according to claim 23 wherein said phase shifting is effected in a manner generally unrelated to the information, if any, being received.

25. A method for phase shifting signals received by a receiving antenna array of N array elements, said method comprising the steps of:
generating a local oscillator signal;
replicating said local oscillator signal to form N copies of said local oscillator signal, a different copy for each element of said array;
mixing said copies of said local oscillator signal with said signals received by said array elements, thereby creating a group of first intermediate signals (IF1);
generating a second local oscillator signal;
replicating said second local oscillator signal to form N copies of said second local oscillator signal, a different copy for each element of said array;
mixing said copies of said second local oscillator signal with said first group of intermediate signals (IF1) to form a second group of intermediate signals (IF2):
shifting the phase of at least one copy of at least one of said local oscillator signals after at least one of said replicating steps, said phase shifting effected by a digital modulating element; and
summing said second group of intermediate signals (IF2) received from said elements of said array.

26. A method for phase shifting a signal transmitted by an array of N elements in a transmitting antenna array, said method comprising the steps of:
modulating a signal;
replicating the modulated signal into N identical intermediate signals (IS) a different one of said intermediate signals delivered to each of said array elements;
generating a local oscillator signal;
replicating said local oscillator signal into N copies for sending a different copy to each array element;
shifting the phase of at least one copy of said local oscillator signal being sent to at least one of said array elements, said phase shifting effected by a digital modulating element; and
mixing said copies of local oscillator signal with at least one of said N intermediate signals.

27. A method for phase shifting a signal transmitted by an antenna array of N elements, said method comprising the steps of:
modulating a signal;
replicating the modulated signal into at least N identical intermediate signals (IS1), one for each of the N array elements;
generating a local oscillator signal and replicating it into at least N identical copies;
mixing a different copy of said local oscillator signal with each of said intermediate signals (IS1), thereby forming a second group of intermediate signals (IS2);
generating a second local oscillator signal and replicating it into at least N identical copies;
mixing a different copy of said second local oscillator signal with each of said second intermediate signals (IS2), thereby forming third intermediate signals (IS3); and
shifting the phase of at least one local oscillator signal copy after one of said generating steps, said phase shifting effected by a digital modulating element.

28. A method for phase aligning multiple signals carried over different paths, the method comprising the step of:
shifting the phase of at least one of said multiple signals so that said different paths have equivalent effective lengths or effective lengths that differ by a predetermined amount, said phase shifting effected by at least one digital modulating element in a manner generally unrelated to the information, if any, being received or transmitted.

29. A method according to claim 28 wherein said multiple signals are carried over the multiple conductors of a bus on a printed circuit board

30. A method according to claim 28 wherein said multiple signals are carried over different wires in a cable

31. A method according to claim 28 wherein said multiple signals are carried over channels at different carrier frequencies.

32. A method for modifying the time at which multiple signals travelling over different paths arrive at a given point along the path, the method comprising the steps of:
delaying said multiple signals travelling over said different paths whereby said paths have equivalent effective lengths, said delaying effected by at least one digital modulating element in a manner generally unrelated to the information, it any, being received or transmitted.

33. An antenna system comprising:
at least one antenna; and
at least one digital modulator wherein said at least one digital modulator shifts the phase of a first signal by control of a second signal, said phase shift generally independent of the information being carried by the first signal.

34. An antenna system according to claim 33, where the antenna system is a receiving antenna system.

35. An antenna system according to claim 33, where the antenna system is a transmitting antenna system.

36. A transmission phased antenna array comprising:
a plurality of N antennas; and
a plurality of N digital modulators, wherein each of said plurality of digital modulators modulates the signal of a different antenna from among said plurality of antennas and wherein at least one but no more than N−1 digital modulators shifts the phase of the signal of a different antenna from among said plurality of antennas, said phase shifts generally being of a different magnitude for each antenna.

37. A method for phase shifting and modulating signals produced by at least one local oscillator in a transmitting antenna array, the method comprising the step of:
shifting the phase of at least one of said signals with a digital modulating element, wherein said modulating element also modulates said signals.
